(19) United States
(12) Patent Application Publication
(10) Pub. No.: US 2009/0266251 A1
(43) Pub. Date: Oct. 29, 2009

(54) Variable cut off printing press having flexible plate and blanket

(75) Inventor: John Sheridan Richards, Barrington, NH (US)

Correspondence Address: Davidson, Davidson & Kappel, LLC, 485 7th Avenue, 14th Floor, New York, NY, 10018, US

(73) Assignee: Goss International Americas, Inc., Dover, NH (US)

(21) Appl. No.: 12/149,203

(22) Filed: Apr. 28, 2008

(51) Int. Cl. B41F 7/02

(52) U.S. Cl. 101/217

(57) ABSTRACT

A printing press is provided including a plate cylinder having an outer perimeter of a first length. A removable flexible continuous tubular plate having an inner perimeter of a second length is disposed about the plate cylinder. The second length is greater than the first length so that the inner perimeter of the removable flexible continuous tubular plate and the outer perimeter of the plate cylinder define a first gap during a printing mode. A method for varying cutoff in a printing press is also provided.

### BACKGROUND OF INVENTION

The present invention relates generally to a printing press and more specifically to a variable cut off printing press having flexible plates and blankets.

U.S. Pat. No. 5,950,536 discloses a variable cut off offset press unit including a blanket cylinder with a fixed diameter and a plate cylinder of a variable diameter. The diameter of the plate cylinder is varied by mounting plate cylinder sleeves of various sizes on the plate cylinder. Each sleeve is proportional to the length of the image to be printed.

U.S. Pat. No. 6,327,975 discloses using a printing press with two or more printing units to print an image on a web. Each printing unit includes a blanket cylinder, a plate cylinder, and an impression cylinder. Each printing unit prints a portion of the image, leaving no unprinted space between the portions of the image. This allows the press to print an image whose dimension in the longitudinal direction of the web is longer than the circumference of each plate cylinder. To eliminate unprinted spaces, each impression cylinder moves into and out of rolling engagement with the associated blanket cylinder, via the web, and the web is only printed on when the blanket cylinder and impression cylinder are engaged. The plate and blanket cylinders of each printing unit are driven at the same speed as the web when the unit is printing on the web and a different speed when the unit is not printing.

U.S. Pat. No. 7,066,088 discloses a variable cut off offset press including at least two sources of ink of at least two different colors, at least two plate cylinders, at least two impression cylinders, and a continuous image transfer belt. Each plate cylinder is adapted to receive printing sleeves of different diameters, enabling the effective length of the printing plate to be changed and allowing images of multiple dimensions to be printed. The image transfer belt is positioned to contact the printing sleeves at respective nips formed with respective impression cylinders. A web passes through a nip formed by the image transfer belt and an impression roller.

### BRIEF SUMMARY OF THE INVENTION

A printing press is provided including a plate cylinder having an outer perimeter of a first length. A removable flexible continuous tubular plate having an inner perimeter of a second length is disposed about the plate cylinder. The second length is greater than the first length so that the inner perimeter of the removable flexible continuous tubular plate and the outer perimeter of the plate cylinder define a first gap during a printing mode.

A method for varying cutoff in a printing press is also provided. The steps include printing an image having a first cutoff using a first removable flexible continuous tubular plate having a first inner perimeter disposed about a plate cylinder, removing the first removable flexible continuous tubular plate from the plate cylinder, placing a second removable flexible continuous tubular plate having a second inner perimeter different from the first inner perimeter so that the second removable flexible continuous tubular plate is disposed about the plate cylinder, and printing an image having a second cutoff different from the first cutoff using the second removable flexible continuous tubular plate.

### BRIEF DESCRIPTION OF THE DRAWINGS

The present invention is described below by reference to the following drawings, in which:

FIG. 1 shows a schematic side view of a four color perfecting offset printing press according to an embodiment of the present invention;

FIG. 2 shows an enlarged schematic side view of a printing unit of the perfecting offset printing press from FIG. 1 with inker form rollers; and

FIG. 3 shows an enlarged view of a printing unit of a nonperfecting offset printing press according to another embodiment of the present invention.

### DETAILED DESCRIPTION

Variable cut off printing presses have been developed to allow for printing products of different sizes on the same printing press without having to change plate and blanket cylinders. Changing plate and blanket cylinders to correspond to the size of the image that needs to be printed can be a time consuming and difficult process. It also may require purchasing and storing cylinders of multiple sizes.

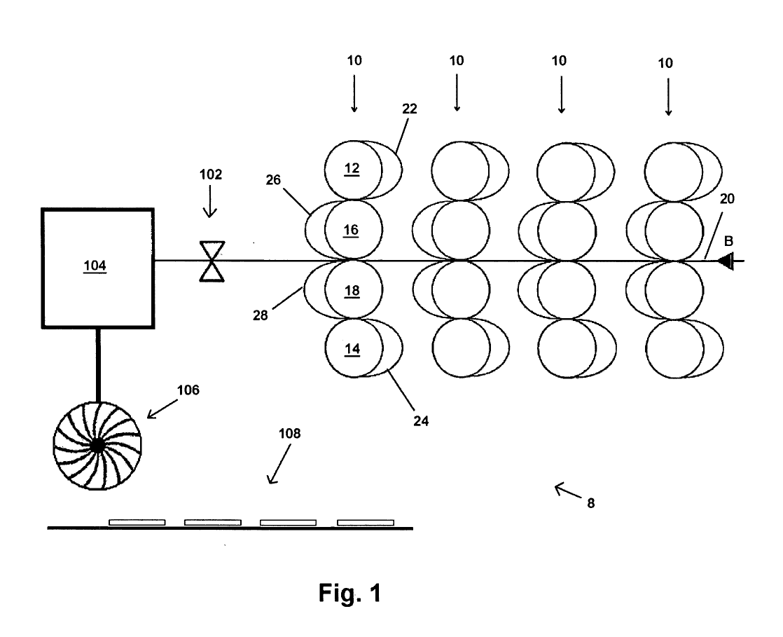

FIG. 1 shows a schematic side view of a four color perfecting offset printing press 8 according to an embodiment of the present invention. Printing press 8 may include four printing units 10, a cutter 102, a folder 104, a delivery fan 106, and a transport belt 108. Each printing unit 10 prints on both sides of a web 20. In each printing unit 10, inkers supply ink to plates 22, 24 on plate cylinders 12, 14, which transfer respective inked images to blankets 26, 28 on blanket cylinders 16, 18. Blankets 26, 28 print images on web 20 moving in the direction of arrow B.

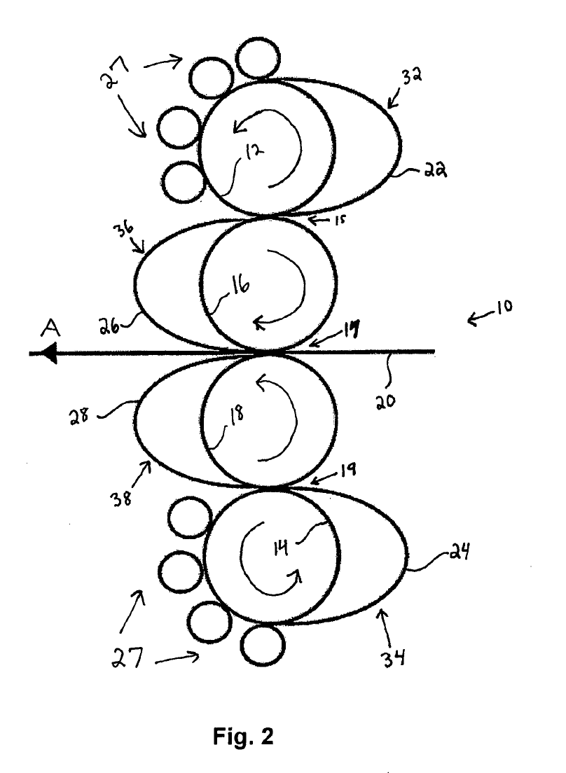

FIG. 2 shows an enlarged schematic side view of printing unit 10 of perfecting offset printing press 8 from FIG. 1 with inker form rollers 27. Printing unit 10 includes first plate cylinder 12, first blanket cylinder 16, second blanket cylinder 18, and second plate cylinder 14. Web 20 passes between blanket cylinders 16, 18 in a direction of an arrow A. Each cylinder 12, 14, 16, 18 has a constant circumference that is less than a smallest potential printed image cutoff. Continuous tubular plates 22, 24 are placed on plate cylinders 12, 14, respectively. Similarly, continuous tubular blankets 26, 28 are placed on blanket cylinders 16, 18, respectively. Plates 22, 24 and blankets 26, 28 are composed of flexible materials. Inkers supply ink to plates 22, 26, which transfer inked images to blankets 26, 28, respectively. Blankets 26, 28 then print the respective inked images on web 20 as blanket cylinders 16, 18 are rotated.

Each plate, 22, 24, has an inner perimeter length that is more than nominally greater than an outer perimeter length of the respective associated plate cylinder, 12, 14. Each blanket, 26, 28, has an inner perimeter length that is more than nominally greater than an outer perimeter length of the respective associated blanket cylinder, 16, 18. Therefore, plates 22, 24 and blankets 26, 28 have excess perimeters 32, 34, 36, 38 in relation to respective associated cylinders 12, 14, 16, 18. Nip points 15, 17, 19 are formed between plate cylinder 12 and blanket cylinder 16, between blanket cylinder 16 and blanket cylinder 18, and between blanket cylinder 18 and plate cylinder 14, respectively. During a printing mode, in which printing unit 10 is in operation, cylinders 12, 14, 16, 18 rotate and the excess perimeters 32, 34, 36, 38 traverse away from respective associated cylinders 12, 14, 16, 18 when not passing through respective nip points 15, 17, 19, and come into contact with the respective outer perimeters of cylinders 12, 14, 16, 18 at nip points 15, 17, 19. The amount of excess perimeter 32, 34, 46, 38 traversing away from cylinders 12, 14, 16, 18 is a function of the perimeters of plates 22, 24 and blankets 26, 28, which are selected to achieve a given cutoff.

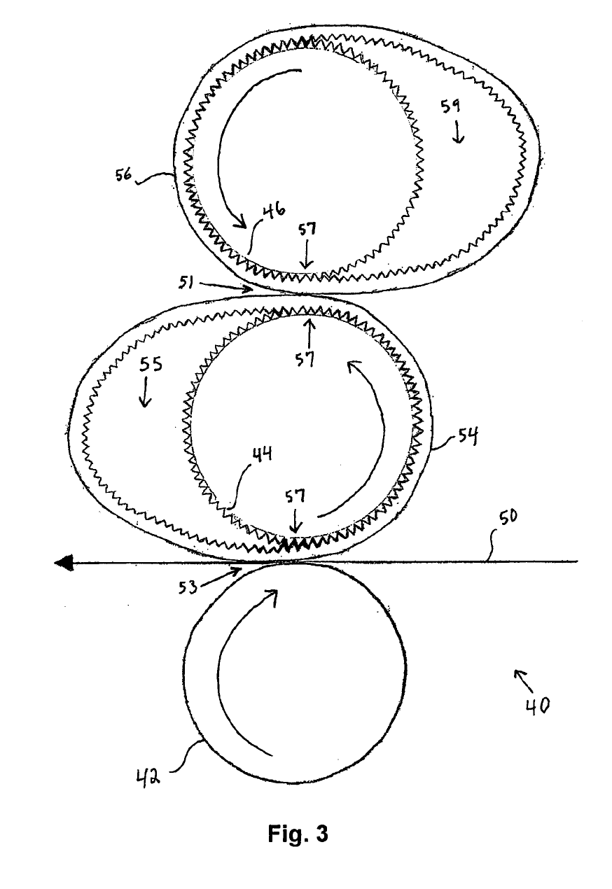

To maintain correct radial positioning, and prevent slipping between the surfaces of the outer perimeters of cylinders 12, 14, 16, 18 and surfaces of the inner perimeters of respective plates 22, 24 and blankets 26, 28 as cylinders 12, 14, 16, 18 are rotated, surfaces of the inner perimeters of plates 22, 24 and blankets 26, 28 and surfaces of the outer perimeters of cylinders 12, 14, 16, 18 may be splined. The splined surfaces, as shown in detail in FIG. 3, maintain positioning by mating in a manner similar to gears in a harmonic drive. Inker form rollers 27 may be utilized to cause portions of the splined surface of blankets 26, 28 to mate with portions of the splined surface of blanket cylinders 16 and 18 at certain desired locations. Alternatively, a spring-loaded tensioner equivalent device could be added to keep excess perimeters 32, 34, 36, 38 under control.

In a preferred embodiment, surface speeds of cylinders 12, 14, 16, 18, inkers, plates 22, 24, and blankets 26, 28 remain essentially equal. The inkers may be geared together if desired, eliminating the requirement for individual shaftless drives.

Changing over to a new printed image cutoff requires only replacing plates 22, 24 with replacement plates, each replacement plate having a new image, and replacing blankets 26, 28 with replacement blankets. The replacement plates and replacement blankets can have respective inner perimeters that vary in length from the inner perimeters of plates 22, 24 and blankets 26, 28, respectively. The replacement plates and replacement blankets are sized to correspond to a new desired image cutoff length. The replacement plates and blankets can also be thicker or thinner than the respective plates 22, 24 and blankets 26, 28 the replacement plates and blankets are replacing. In a preferred embodiment, the images on plates 22, 24 and the replacement plates should cover the entire outer perimeter of continuous plates 22, 24 and the replacement plates, respectively.

Before plates 22, 24 and blankets 26, 28 are removed and replaced with replacement plates and blankets, during a printing mode web 20 will be printed with images having a cutoff essentially equal to the length of the perimeter of each plate 22, 24. After plates 22, 24 and blankets 26, 28 are removed and replaced with replacement plates and blankets, web 20 will be printed with images having a cutoff essentially equal to the length of the perimeter of each replacement plate. Cylinders 12, 14, 16, 18 will not need to be changed to vary the cutoff. Additionally, the positioning of cylinders 12, 14, 16, 18 may not need to be moved when printing in a new cutoff. Replacement plates and blankets, although having different respective perimeters than plates 22, 24 and blankets 26, 28 and therefore providing for a new cutoff, may be of the same thickness as plates 22, 24 and blankets 26, 28, which the replacement plates and blankets are replacing.

FIG. 3 shows an enlarged schematic side view of a printing unit 40 of a nonperfecting offset printing press according to another embodiment of the present invention. Printing unit 40 includes an impression cylinder 42, a blanket cylinder 44, and a plate cylinder 46. A plate 56 is traversely disposed about plate cylinder 46 and a blanket 54 is traversely disposed about blanket cylinder 44. Plate 56 and blanket 54 are each continuous and are composed of flexible material. Inkers supply ink to plate 56, which transfers an inked image to blanket 54, which prints the image on a passing web 50.

The surfaces of the inner perimeters of plate 56 and blanket 54 and the surfaces of the outer perimeters of plate cylinder 46 and blanket cylinder 44 are splined. The length of the inner perimeter of blanket 54 is greater than the outer perimeter of blanket cylinder 44. The length of the inner perimeter of plate 56 is also greater than the length of the outer perimeter of plate cylinder 46. As cylinders 44, 46 are rotated, a surface of the inner perimeter of plate 56 is pressed against a surface of the outer perimeter of plate cylinder 46 at a nip 51 formed by plate 56 and blanket 54. Inkers contacting plate 56 may also cause the surface of the inner perimeter of plate 56 to contact the surface of the outer perimeter of plate cylinder 46. A surface of the inner perimeter of blanket 54 is pressed against a surface of the outer perimeter of blanket cylinder 44 at nip 51 and at a nip 53 formed by blanket 54 and impression cylinder 42. At nips 51, 53, the splined surfaces of blanket 54 and plate 56 mate with the respective splined surfaces of blanket cylinder 44 and plate cylinder 46, forming spline mating positions. These spline mating positions 57 act to maintain correct radial positioning of blanket 54 and plate 56 as cylinders 44, 46 rotate. Splined surfaces of plate cylinder 46 and plate 56 may also mate at positions other than nips 51, 53, depending on the amounts of force applied by inkers and cylinders 44, 46 to plate 56 and a speed at which cylinders 42, 44, 46 are rotated. Similarly, splined surfaces of blanket cylinder 44 and blanket 54 may also mate at positions other than nips 51, 53, depending on the amounts of force applied by cylinders 42, 44, 46 and web 50 and a speed at which cylinders 42, 44, 46 are rotated.

The surface of the inner perimeter of blanket 54 not contacting the surface of the outer perimeter of blanket cylinder 44 during printing mode traverses away from blanket cylinder 44 and may form a gap 55 on a side of blanket cylinder 44 if forces cause substantially an entire side of the surface of the outer perimeter of plate cylinder 46 to mate with the surface of the inner perimeter of plate 56, as shown in FIG. 3. The surface of the inner perimeter of plate 56 may interact with the outer surface of plate cylinder 46 in a similar manner and also form a gap 59 on a side of plate cylinder 46. Alternatively, tensioners may be employed to act on plate 56 and blanket 54 to produce a similar result.

The embodiment shown in FIG. 3 may allow plate cylinder 46 and blanket cylinder 44 to be in close proximity to one another, but at the same time may allow larger cutoffs than would be possible if the lengths of the inner perimeters of plate 56 and blanket 54 were substantially equal to the lengths of the outer perimeters of plate cylinder 46 and blanket cylinder 44, respectively. Blanket 54 and plate 56 can be replaced with replacement blankets and plates that have greater inner perimeters than blanket 54 and plate 56, but are the same thickness as blankets 54, 56, thus allowing a larger cutoff, yet maintaining the positional relationship between plate cylinder 46 and blanket cylinder 44.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A printing press comprising:
a plate cylinder having an outer perimeter of a first length; and
a removable flexible continuous tubular plate having an inner perimeter of a second length disposed about the plate cylinder;
the second length being greater than the first length so that the inner perimeter of the removable flexible continuous tubular plate and the outer perimeter of the plate cylinder define a first gap during a printing mode.

2. The printing press recited in claim 1 further comprising a blanket disposed about a blanket cylinder contacting the removable flexible continuous tubular plate during the printing mode.

3. The printing press recited in claim 1 further comprising:
a blanket cylinder having an outer perimeter of a third length; and
a removable flexible continuous tubular blanket having an inner perimeter of a fourth length disposed about the blanket cylinder;
the fourth length being greater than the third length so that the inner perimeter of the removable flexible continuous tubular blanket and the outer perimeter of the blanket cylinder define a second gap during the printing mode, the removable flexible continuous tubular blanket and the removable flexible continuous tubular plate contacting during the printing mode.

4. The printing press recited in claim 3 further comprising an impression cylinder defining a nip with the removable flexible continuous tubular blanket during the printing mode.

5. The printing press recited in claim 3 further comprising a second blanket disposed about a second blanket cylinder, a second plate disposed about a second plate cylinder, the second plate contacting the second blanket and the second blanket defining a nip with the removable flexible continuous tubular blanket during the printing mode.

6. The printing press recited in claim 3 wherein the first gap and the second gap are a function of a desired cutoff length.

7. The printing press recited in claim 3 wherein the first length and the third length are substantially equal and the second length and the fourth length are substantially equal.

8. The printing press recited in claim 3 wherein a surface of the inner perimeter of the removable flexible continuous tubular plate is splined, a surface of the outer perimeter of the plate cylinder is splined, a surface of the inner perimeter of the removable flexible continuous tubular blanket is splined, and a surface of the outer perimeter of the blanket cylinder is splined.

9. The printing press recited in claim 1 wherein the first gap is a function of a desired cutoff length.

10. The printing press recited in claim 1 wherein a surface of the inner perimeter of the removable flexible continuous tubular plate is splined and a surface of the outer perimeter of the plate cylinder is splined.

11. A method for varying cutoff in a printing press comprising the steps of:
printing an image having a first cutoff using a first removable flexible continuous tubular plate having a first inner perimeter disposed about a plate cylinder;
removing the first removable flexible continuous tubular plate from the plate cylinder;
placing a second removable flexible continuous tubular plate having a second inner perimeter different from the first inner perimeter so that the second removable flexible continuous tubular plate is disposed about the plate cylinder; and
printing an image having a second cutoff different from the first cutoff using the second removable flexible continuous tubular plate;
wherein the first inner perimeter is larger than an outer perimeter of the plate cylinder.
